(19) United States
(12) Patent Application Publication
(10) Pub. No.: US 2016/0101616 A1
(43) Pub. Date: Apr. 14, 2016

(54) DEVICE AND METHOD FOR REPLACING THE PRINTING ROLLERS OF A PRINTING UNIT, PARTICULARY FOR IN-LINE FLEXOGRAHPIC ROTARY MACHINES

(71) Applicant: BOBST FIRENZE S.R.L., Campi Bisenzio (Firenze) (IT)

(72) Inventors: Federico D'ANNUNZIO, Firenze (IT); Giacomo MACCALLI, Lodi (IT); Mauro MACCALLI, Lodi (IT)

(21) Appl. No.: 14/894,160

(22) PCT Filed: Apr. 11, 2014
(86) PCT No.: PCT/EP2014/057431

§ 371 Date: Nov. 25, 2015

(30) Foreign Application Priority Data
Jun. 18, 2013 (IT) MI 2013 A 001003

(51) Int. Cl. B41F 27/00

(52) U.S. Cl. CPC B41F 27/00

(57) ABSTRACT

A device for replacing the printing rollers of a printing unit, particularly for in-line flexographic rotary machines is disclosed and includes a work station for a first, working printing roller,—a holding station for a second printing roller,—a removal station for a printing roller to be removed,—movement means, for the movement of the first printing roller from the work station to the removal station and for the movement of the second printing roller from the holding station to the work station.

The present invention relates to a device for replacing the printing rollers of a printing unit, particularly for in-line flexographic rotary machines.

Nowadays, in the field of printing, and in particular in the field of printing labels and flexible packaging, the need is widely felt to increase the general efficiency of printing processes, on the one hand by reducing printing times and on the other hand by limiting the waste of material, such as the print medium.

In particular, the step of changing the printing rollers is one of the most critical steps of the entire printing process, in that the “job-change” times are dead times, in which the printing process is substantially interrupted. Furthermore, changing between two different print jobs generally involves great waste of material.

The aim of the present invention consists in providing a device for replacing the printing rollers of a printing unit, particularly for in-line flexographic rotary machines, which solves the above mentioned technical problems, eliminates the drawbacks and overcomes the limitations of the known art, by making it possible to increase the efficiency of printing processes.

Within this aim, an object of the present invention is to provide a device for replacing the printing rollers of a printing unit which makes it possible to reduce the “job-change” times and the wastes of material that are associated with such a “job-change”.

Another object of the invention consists in providing a device for replacing the printing rollers of a printing unit which enables its application, in a flexible manner, on printing units that use different printing methods.

Another object of the invention consists in providing a device for replacing the printing rollers of a printing unit which is capable of offering the widest guarantees of reliability and safety in use.

Another object of the invention consists in providing a device for replacing the printing rollers of a printing unit which is easy to implement and economically competitive when compared to the known art.

This aim and these and other objects which will become better apparent hereinafter, are achieved by a device for replacing the printing rollers of a printing unit, particularly for in-line flexographic rotary machines, characterized in that it comprises:
a work station for a first, working printing roller,
a holding station for a second, held printing roller,
a removal station for a printing roller to be removed,
movement means for the movement of said first printing roller from said work station to said removal station and for the movement of said second printing roller from said holding station to said work station.

This aim and these and other objects are also achieved by a method for replacing printing rollers of a printing unit, particularly for in-line flexographic rotary machines, which is characterized in that it comprises the steps of:
having a first printing roller working in a work station;
having a second printing roller held in a holding station;
moving, by way of movement means, said first printing roller from said work station to a removal station, and following, by way of said movement means, said second printing roller from said holding station to said work station;
removing said first printing roller from said removal station.

Further characteristics and advantages of the invention will become better apparent from the detailed description of a preferred, but not exclusive, embodiment of a device for replacing the printing rollers of a printing unit, particularly for in-line flexographic rotary machines, which is illustrated by way of non-limiting example with the aid of the accompanying drawings wherein:

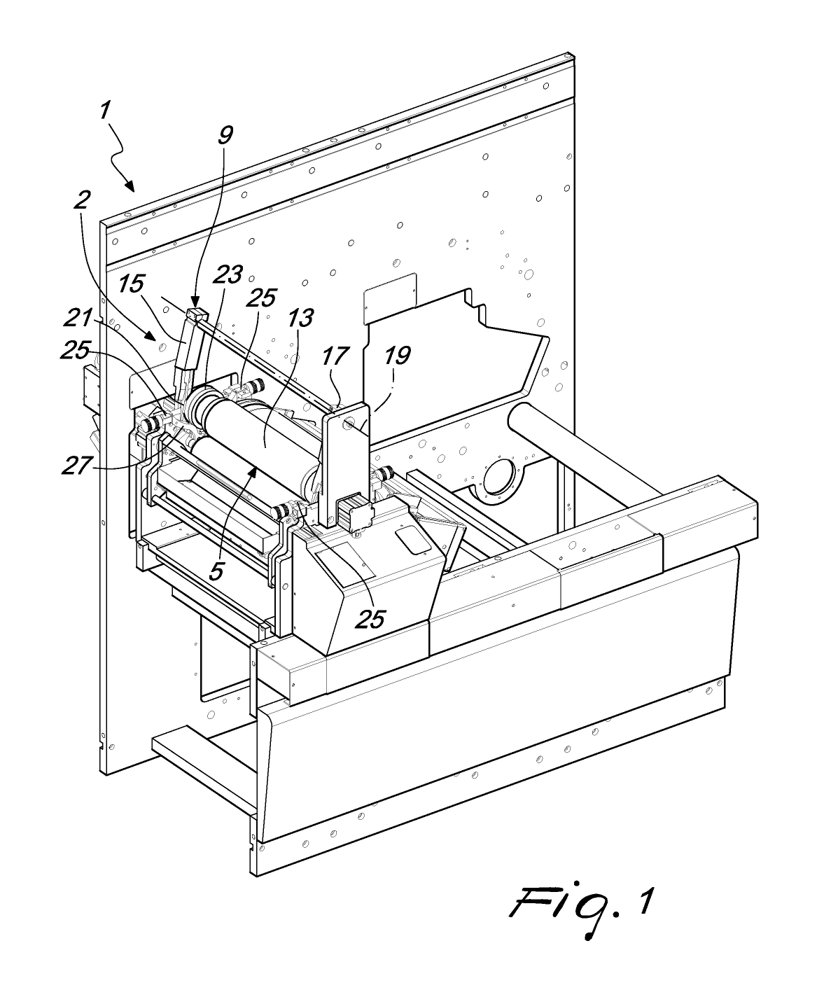

FIG. 1 is a perspective view of a printing unit of a flexographic machine in which there is an embodiment of the device for replacing the printing rollers, according to the invention;

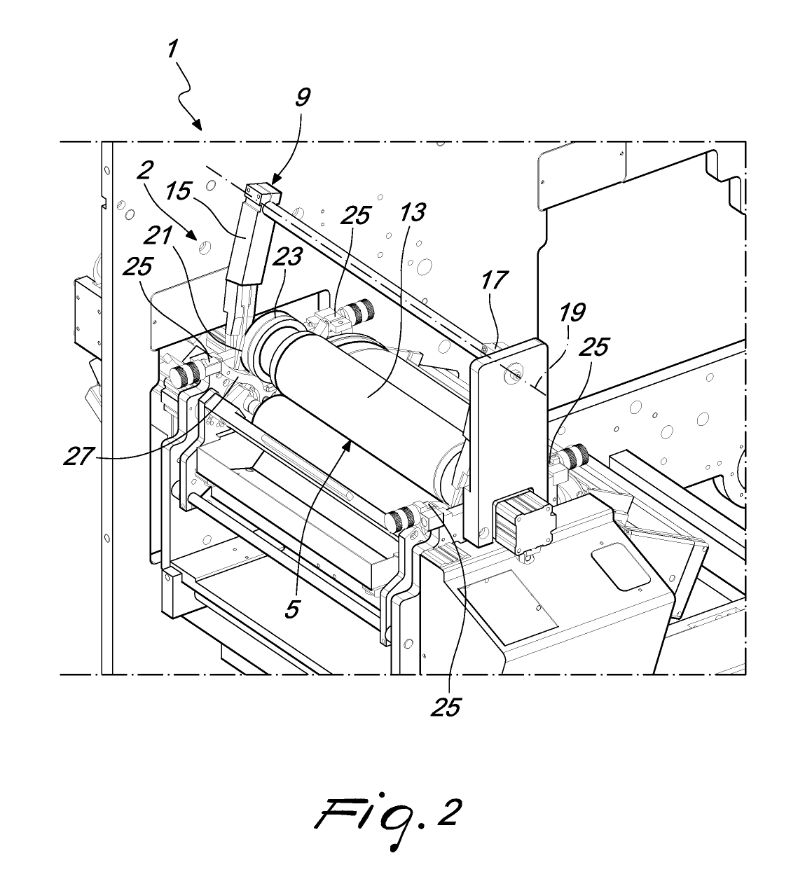

FIG. 2 is an enlargement of a portion of FIG. 1, showing in particular the printing unit, with the device for replacing the printing rollers, according to the invention;

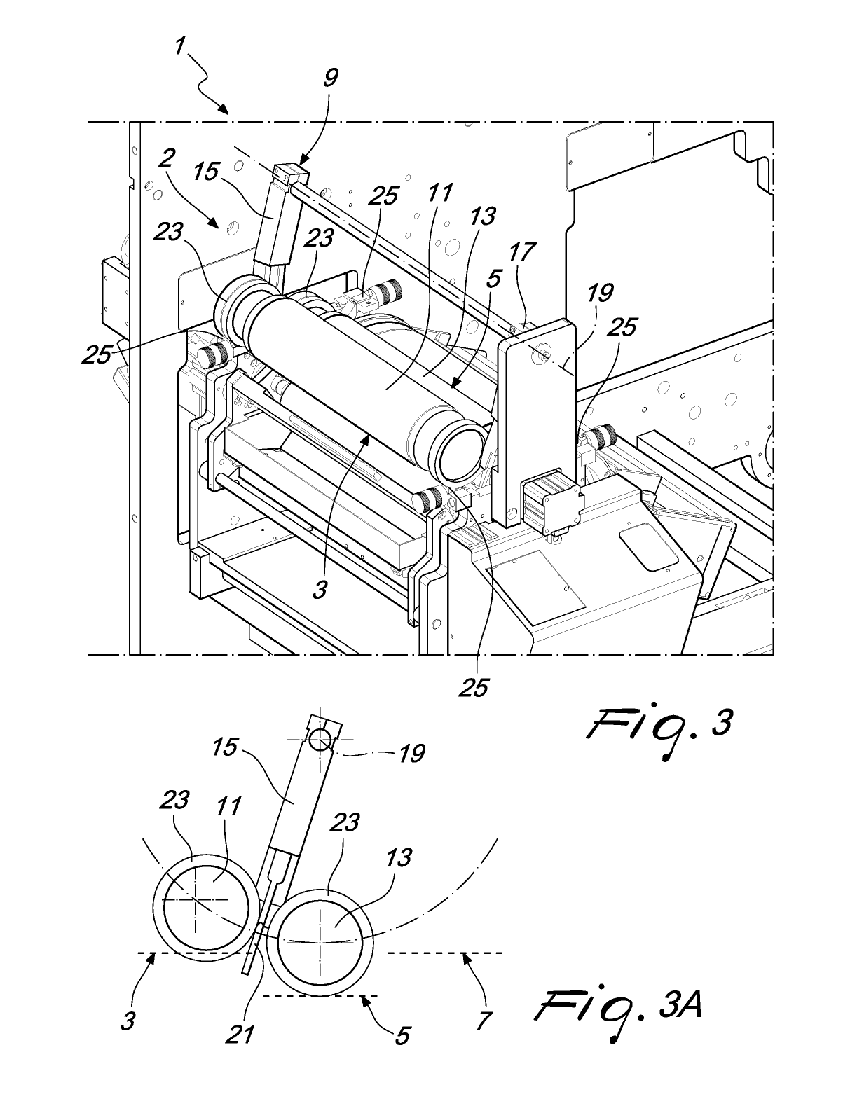

FIG. 3 shows the same enlargement as FIG. 2, in a situation in which a printing roller is shown held in a holding station, as well as a printing roller working in a work station;

FIG. 3A is a schematic diagram of the situation in FIG. 3;

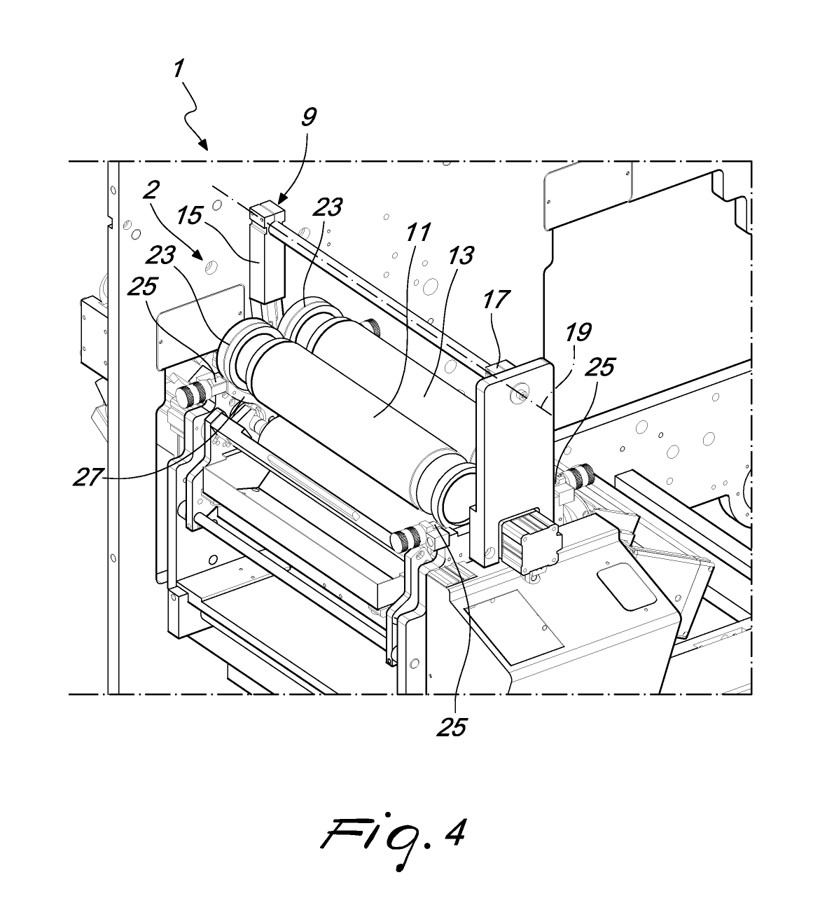

FIG. 4 shows the same enlargement as FIG. 2, in a situation in which a step is shown of moving the printing roller that was held in the holding station, and of moving the printing roller that was working in the work station;

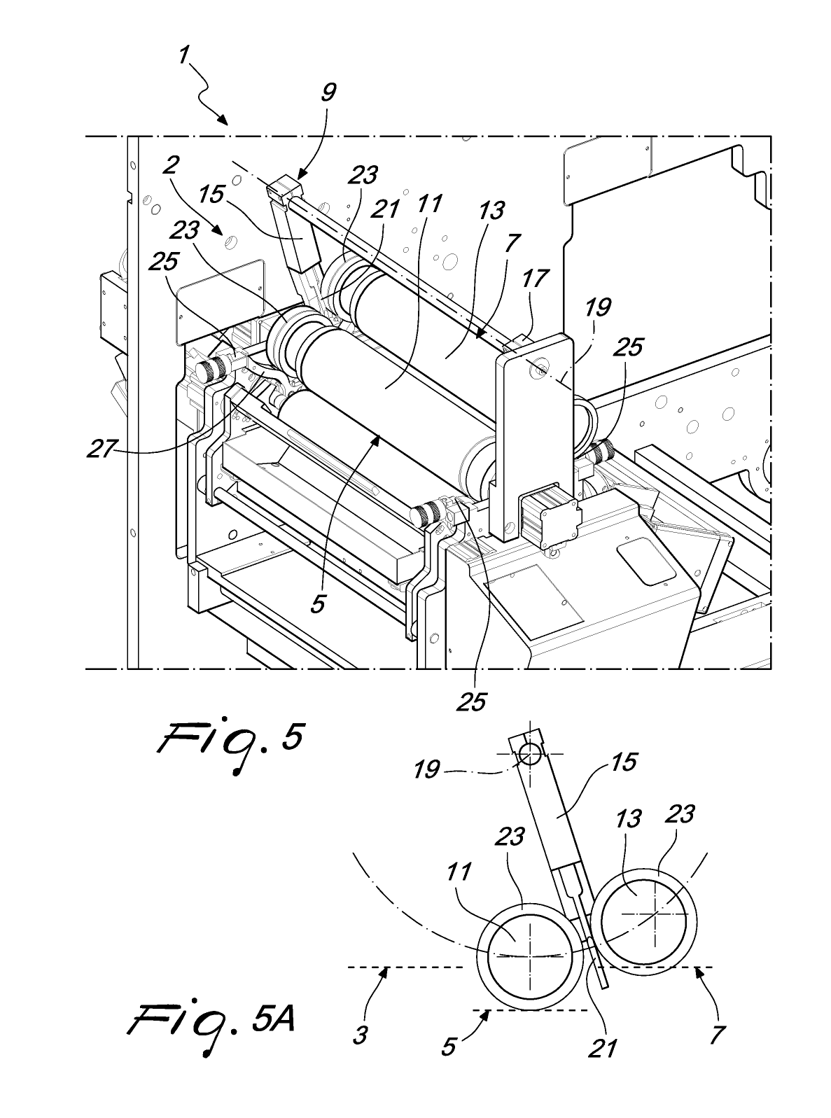

FIG. 5 shows the same enlargement as FIG. 2, in a situation in which a printing roller is shown working in a work station, as well as a printing roller to be removed in a removal station;

FIG. 5A is a schematic diagram of the situation in FIG. 5.

With reference to the figures, the device for replacing the printing rollers of a printing unit, particularly for in-line flexographic rotary machines, is generally designated by the reference numeral 1, while the printing unit is designated by the reference numeral 2.

According to the invention, the device 1 comprises:
a work station 5 for a first, working printing roller 13,
a holding station 3, 7 for a second, held printing roller 11,

a removal station 7, 3 for a printing roller 11, 13 to be removed,
movement means 9, for the movement of the first printing roller 13 from the work station 5 to the removal station 7, 3 and for the movement of the second printing roller 11 from the holding station 3, 7 to the work station 5.

In the accompanying figures, the holding station is designated with the reference numeral 3, while the removal station is designated with the reference numeral 7, because in the case shown, the movement of the rollers 11, 13 occurs from left to right. However, the station designated with the reference numeral 3 can be a removal station, and the station designated with the reference numeral 7 can be a holding station, i.e. the holding and removal stations can switch their roles when the movement of the rollers 11, 13 occurs from right to left.

Advantageously, the movement means 9 comprise a pair of rods 15, 17 that are pivoted with respect to a pivoting axis 19, each one of the rods 15, 17 comprising an abutment protrusion 21 that is adapted to engage the lateral ends of the first printing roller 13 and of the second printing roller 11.

Furthermore, the lateral ends of the two printing rollers 11 and 13 advantageously comprise lateral discs 23, which are adapted to be engaged by the abutment protrusions 21 of the rods 15, 17.

Advantageously, the holding station 3 (and the removal station 7) are at a higher level than that at which the work station 5 is arranged. The movement means 9, in fact, follow the sliding by gravity of the second printing roller 11 from the holding station 3 to the work station 5. Obviously, when the station 7 plays the role of holding station, the movement means 9 follow the sliding by gravity of the printing roller 11, 13 from the station 7 to the work station 5.

Furthermore, the holding and removal stations 3, 7 advantageously comprise at least one stop element 25 in order to prevent the fall of the printing rollers 11, 13 laterally from the device 1, i.e. outside the printing unit 2.

The device 1 advantageously comprises sliding tracks 27 for the sliding of the printing rollers 11 and 13 from the holding station 3 to the work station 5 and from the work station 5 to the removal station 7. Advantageously, furthermore, it is the lateral discs 23 of the printing rollers 11 and 13 that slide and/or rotate on the above mentioned sliding tracks 27.

The device 1 for replacing the printing rollers can be advantageously comprised in one or more, and preferably in all of the printing units 2 that are present in a flexographic machine, and in particular in an in-line flexographic rotary machine.

The invention also relates to a method for replacing printing rollers of a printing unit 2, particularly for in-line flexographic rotary machines, which comprises the steps of:
having a first printing roller 13 working in a work station 5;
having a second printing roller 11 held in a holding station 3;
moving, by way of movement means 9, the first printing roller 13 from the work station 5 to the removal station 7, and following, again by way of the same movement means 9, the second printing roller 11, from the holding station 3 to the work station 5;
removing the first printing roller 13 from the removal station 7.

In this case also, the roles of the stations 3 and 7 can be conveniently switched.

Furthermore, the step of moving the first printing roller 13 and following the second printing roller 11 is advantageously performed without stopping the printing process, and also advantageously it can be performed at any stage of the printing process.

Operation of the device is clear and evident from the foregoing description.

In particular, the device 1 makes it possible to position a new printing roller 11 on the printing unit 2 in a holding station 3, while the printing roller 13 that is working in the work station 5 is completing the printing procedure. At the end of the printing step, the movement means 9 make the printing roller 13 that was working perform a translational motion laterally, along the sliding tracks 27, bringing it to the removal station 7, and at the same time allowing the sliding, by gravity along the sliding tracks 27, of the new printing roller 11, which was held in the holding station 3, into the work station 5, in order to resume working. The printing roller 13, which has finished working, is now available for removal from the removal station 7. In short, the printing rollers 11 and 13 are moved from left to right, thanks to the movement means 9.

The substitution of the printing roller 11, which is now working, can be performed by positioning an additional new roller, not shown, in the station 7, and repeating the movement steps described in the other direction, i.e. sliding, by way of the movement means 9, the printing rollers from right to left.

Furthermore, if the device 1 is applied on all the printing units 2 of an in-line flexographic rotary machine, it is possible to change the printing rollers both selectively and sequentially.

With selective changing, in the event that only one roller needs to be changed, for example, in order to have a new text, a new language etc., the change can be done “on the fly” with no waste of material owing to machine shutdown, and to the consequent loss of the print register. The machine is not stopped, the device 1 performs the change on the selected printing station, with no loss or waste of any kind, immediately and perfectly in register.

With sequential changing, when the print job is to be changed, the changing of printing rollers occurs starting from a first printing unit, in which the “new” roller substitutes the “old” roller, as a result beginning to print the “new” job. The “old” job continues on its way to a second printing unit, and when the “new” job printed by the first printing unit arrives, the “new” printing roller of the second unit takes over from the old roller, printing the second color of the “new” job, perfectly in register with the first color of the new job, with no waste between the “old” and “new” jobs. The “old” job thus continues to a third printing unit, and when the “new” job printed by the first and by the second printing unit arrives, the “new” printing roller of the third group takes over from the old roller, printing the third color of the “new” job, perfectly in register with the first color and with the second color of the “new” job, with no waste between the “old” and “new” jobs. And so on for all the subsequent printing units, the procedure cascades with a sequential substitution of the “old” job with the “new” job without leaving any waste of material between the two jobs.

In practice it has been found that the device and the method for replacing the printing rollers of a printing unit, particularly for in-line flexographic rotary machines, according to the present invention, achieve the intended aim and objects in that they make it possible to increase the efficiency of the printing process, by reducing the job-change times and reducing the wastes of material. In fact, changing the rollers can be done at low speed without stopping the flexographic machine. This makes it possible to perform the job-change without disturbing the tension of the print medium, which continues to be entrained, and thus without loss of register, both in the “old” print job and in the “new” print job.

Another advantage of the device, according to the invention, consists in that it can be easily removed from the printing unit, with few operations, and thus it enables the rapid insertion into flexographic printing units of other printing processes.

The device and the method for replacing the printing rollers of a printing unit, particularly for in-line flexographic rotary machines, thus conceived, are susceptible of numerous modifications and variations, all of which are within the scope of the appended claims.

Moreover, all the details may be substituted by other, technically equivalent elements.

In practice the materials employed, provided they are compatible with the specific use, and the contingent dimensions and shapes, may be any according to requirements.

The disclosures in Italian Patent Application No. MI2013A001003 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1.-10. (canceled)

11. A device for replacing the printing rollers of a printing unit, particularly for in-line flexographic rotary machines comprising:
a working station for a first printing roller,
a holding station for a second, held printing roller,
a removal station for said first printing roller to be removed,
movement means for the movement of said first printing from said work station to said removal station and for the movement of said second printing roller from said holding station to said work station,
wherein:
said movement means comprise a pair of rods that are pivoted with respect to a pivoting axis, each one of said rods comprising an abutment protrusion that is adapted to engage the lateral ends of said first printing roller and of said second printing roller,
said holding station and said removal station are at a higher level than that of said work station,
the rotation of said rods around said pivoting axis defining a region, said working station being arranged inside said region;
said removal station and said holding station being arranged outside said region on mutually opposed sides thereof, said holding station, said working station, and said removal station being affected by the rotation of said rods within said region;
thereby said pair of rods are adapted to move said first roller toward the removal station rotating around said pivoting axis, as consequence the second roller moving by gravity from the holding station to the working station.

12. The device according to claim 11, wherein said lateral ends of said first printing roller and of said second printing roller comprise lateral discs that are adapted to be engaged by said abutment protrusions of said rods.

13. The device according to claim 12, wherein it comprises sliding tracks for the sliding of said first printing roller and of said second printing roller from said holding station to said work station and from said work station to said removal station.

14. The device according to claim 13, wherein said lateral discs of said rollers slide and/or rotate on said sliding tracks during the moving of said rollers itself from said holding station to said work station and from said work station to said removal station.

15. The device according to claim 11, wherein said holding station and said removal station comprise at least one stop element in order to prevent the fall of said first printing roller or of said second printing roller from said device.

16. A flexographic machine comprising a plurality of printing units, wherein each printing unit comprises a device for replacing the printing rollers according to claim 11.

17. A method for replacing printing rollers of a printing unit, particularly for in-line flexographic rotary machines comprising the steps of:
having a first printing roller working in a work station;
having a second printing roller held in a holding station;
moving, by way of movement means, said first printing roller from said work station to a removal station and following, by way of said movement means, said second printing roller from said holding station to said work station,
removing said first printing roller from said removal station; wherein said method comprising:
said movement means rotating around a pivoting axis effecting the movement of said first roller toward the removal station and at the same time the second roller follows the rotation of said movement means moving by gravity from the holding station to the working station.

18. The method according to claim 17, wherein said step of moving said first printing roller and of following said second printing roller is performed without stopping the printing process.

19. The method according to claim 17, wherein said step of moving said first printing roller and of following said second printing roller performed at any stage of the printing process.
